(19) United States
(12) Patent Application Publication
(10) Pub. No.: US 2012/0290277 A1
(43) Pub. Date: Nov. 15, 2012

(54) SYSTEM AND METHOD FOR CHARACTERIZING RESERVOIR FORMATION EVALUATION UNCERTAINTY

(75) Inventors: Julian Thorne, Orange, CA (US); Bruce Bilodeau, Danville, CA (US); Jean-baptiste Clavaud, Houston, TX (US)

(73) Assignee: Chevron U.S.A. Inc., San Ramon, CA (US)

(21) Appl. No.: 13/468,150

(22) Filed: May 10, 2012

Related U.S. Application Data
(60) Provisional application No. 61/484,398, filed on May 10, 2011.

(51) Int. Cl. G06G 7/48

(52) U.S. Cl. 703/10

(57) ABSTRACT

A method is provided that utilizes independent data spatial bootstrap to quantitatively derive P10, P50 and P90 reservoir property logs and zonal averages. The method utilizes at least a “baseline” dataset that is assumed to be correct, and determines the distribution of possible input parameter values that provide the most optimal solution to fit the log analysis to the core data. In one embodiment, independent data spatial bootstrap method can be applied to determine the uncertainty of porosity and saturation.

### PRIORTITY CLAIM AND CROSS-REFERENCE TO RELATED APPLICATIONS

The present patent application claims priority to U.S. Patent Application Ser. No. 61/484,398 filed on May 10, 2011, entitled “System and Method for Characterizing Formation Evaluation Uncertainty, and is related to U.S. patent application Ser. No. 13/297,092, entitled “System and Method of Using Spatially Independent Subsets of Data to Calculate Property Distribution Uncertainty of Spatially Correlated Reservoir Data”, U.S. Patent Application Ser. No. 61/560,091, entitled “System and Method of Using Spatially Independent Subsets of Data To Determine the uncertainty of Soft-Data Debiasing of Property Distributions for Spatially Correlated Reservoir Data” and U.S. patent application Ser. No. 13/297,070, entitled “Method of Using Spatially Independent Subsets of Data to Calculate Vertical Trend Curve Uncertainty of Spatially Correlated Reservoir Data,” all of which are herein incorporated by reference in their entireties.

### FIELD OF THE INVENTION

The present invention relates generally to a system and method for characterizing reservoir formation evaluation uncertainty, and in particular, a system and method for spatially bootstrapping to characterize the uncertainty of reservoir formation evaluation.

### BACKGROUND OF THE INVENTION

Reservoir properties can be derived from well logs, e.g., wireline, logging-while-drilling (LWD) or cased-hole logs, etc., by using petrophysical models that relate petrophysical parameters such as water salinity, temperature, density of the grain, mineralogical composition, etc., and well logs to the desired final reservoir properties such as porosity, saturation, etc. Examples of such petrophysical models can be expressed generally in the form of Equation 1:

Reservoir Propertyₙ=f(log₁ . . . logₖ, Paramater₁ Paramaterₙ) (Equation 1)

A specific example for porosity can be expressed in the form of Equation 2:

$$Porosity = \frac{{RHOB}_{grain} - {RHOB}_{log measured}}{{RHOB}_{grain} - {RHOB}_{fluid}} \qquad ( Equation 2 )$$

where RHOB_{grain} and RHOB_{grain} are parameters that are laboratory measurements or best estimates, and where RHOB_{log measured} is the well log measurement itself.

Potentially many of these equations, either one by one (deterministic step by step approach) or simultaneously (inversion of all equations at the same time in a probabilistic fashion using modeling tools such as ELAN™ or MinSolve™), must be solved to properly characterize reservoir properties one. This requires the knowledge of all parameters that go into a model, i.e., “input model parameters,” some of which may introduce model uncertainties and may ultimately increase volumetric uncertainty.

An accurate assessment of volumetric uncertainty is critical to determining the uncertainty of reserves estimates and developing an effective uncertainty management plan. Conventional Monte Carlo methods for estimating the uncertainties of reservoir properties can lead to highly subjective estimates of uncertainty because they are calculated from input model parameter uncertainties. Typically, this requires a petrophysicist to estimate an uncertainty range for an input model parameter based on the range of values obtained from a core analyses or published literature.

Conventional “bootstrapping” methods, though objective, assume incorrectly that each property data collected is an independent measurement. “Bootstrapping” generally refers to statistical resampling methods that allow uncertainty in data to be assessed from the data itself, in other words, given the independent observations Zᵢ, i=1, . . . , n and a calculated statistic S, e.g., the mean, what is uncertainty of S? This can be accomplished in accordance with the following procedure: (a) draw n values i=1, . . . , n from the original data with replacement; (b) calculate the statistic S′ from the “bootstrapped” sample; and (3) repeat L times to build up a distribution of the uncertainty in S.

Thus conventional approaches require accurate “a priori” knowledge of the ranges for given input model parameters, and they do not ensure that resulting ranges of reservoir properties match what is measured or inferred from reference data (core data for example). Conventional methods may require multiple iterations that are expensive and time consuming and which may not yield accurate reserve estimates.

### SUMMARY OF THE INVENTION

A computer-implemented method is provided for characterizing hydrocarbon reservoir formation evaluation uncertainty. The method includes the steps of: accessing petrophysical reference data; deriving an a-priori uncertainty distribution of petrophysical model input parameters and a non-uniqueness of calibration of field data to the petrophysical reference data; deriving multiple petrophysical model solutions using the a-priori uncertainty distribution of petrophysical model input parameters that fit within a predetermined tolerance a plurality of the petrophysical reference data; deriving a posteriori distribution of input model parameters from the multiple petrophysical model solutions; and applying the posteriori distribution of petrophysical model input parameters to derive an a-priori uncertainty distribution of selected petrophysical model output.

In another embodiment, a computer-implemented method for characterizing hydrocarbon reservoir formation evaluation uncertainty includes the steps of: inputting petrophysical reference data comprising substantially spatially correlated data; choosing a plurality of subsets N of data, the N subsets of data each being substantially less spatially correlated than the petrophysical reference data but still representative of the petrophysical reference data; and applying a bootstrap process on each of the N subsets of data to obtain a bootstrap data set from each of the N subsets of data. For each of the bootstrap datasets, the method further includes the steps of inverting a petrophysical model to generate a set of optimized petrophysical model input parameter values, wherein the inverting step includes varying model input parameter values for the petrophysical model within user-defined ranges such that output of the petrophysical model matches is a best fit to petrophysical reference data; collecting the set of optimized petrophysical model input parameters; performing a statistical significance test the set of optimized petrophysical model input parameters and the corresponding fit to the petrophysical reference data; repeating the bootstrap process and inverting step M times to generate M×N sets of optimized petrophysical model input parameters; selecting from M×N sets of optimized petrophysical model input parameters those sets optimized petrophysical model input parameters that satisfy at predetermined criteria for statistical significance; executing the petrophysical model using the selected sets of optimized petrophysical model input parameters on a plurality of data within a hydrocarbon reservoir formation; and determining selected percentiles representative of selected reservoir uncertainties from the distribution of values produced by different sets of optimized petrophysical model input parameters.

In another embodiment, the method utilizes independent data spatial bootstrap to quantitatively derive P10, P50 and P90 reservoir property logs and zonal averages. The method utilizes at least a “baseline” dataset that is assumed to be correct (e.g., core data), and determines the distribution of possible input parameter values that provide the most optimal solution to fit the log analysis to the core data. In one embodiment, independent data spatial bootstrap method can be applied to determine the uncertainty of porosity and saturation.

In another embodiment, a system is provided for characterizing hydrocarbon reservoir formation evaluation uncertainty. The system includes a data source having petrophysical reference data, and a computer processor operatively in communication with the data source and having a processor configured to access the petrophysical reference data and to execute a computer executable code responsive to the petrophysical reference data. In one embodiment, the computer executable code includes: a first code for accessing the petrophysical reference data; a second code for applying a variogram to the sample petrophysical data to select a plurality of subsets N of data, the N subsets of data being substantially less correlated than the sample petrophysical data; a third code for applying a spatial bootstrap process on each of the N subsets of data to obtain a plurality of bootstrap data sets from each of the N subsets of data; a fourth code for inverting, each of the N subsets of data, a petrophysical model to generate a set of optimized petrophysical model input parameter values, wherein the inverting code varies model input parameter values for the petrophysical model within user-defined ranges such that output of the petrophysical model matches the petrophysical reference data within a predetermine threshold; a fifth code for collecting the set of optimized petrophysical model input parameters values; a sixth code for performing a statistical significance test on each set of optimized petrophysical model input parameter values; a seventh code for causing the spatial bootstrap process and inverting to be repeated M times to generate M×N sets of optimized petrophysical model input parameter values; an eight code for selecting from M×N sets of optimized petrophysical model input parameter values those sets optimized petrophysical model input parameter values that satisfy at predetermined criteria for the statistical significance test; a ninth code for executing the petrophysical model using the selected sets of optimized petrophysical model input parameter values; and a tenth code for determining selected percentiles representative of selected reservoir uncertainties.

The present invention provides a user the ability to characterize reservoir property uncertainty without: (1) requiring accurate “a priori” knowledge of the range of input model parameters (physically possible range is all that is required); and (2) without running lengthy Monte-Carlo or other similar types of simulations to provide the range of parameters that match the reference data (e.g., core data).

The present invention relies on bootstrap technology and includes taking a subset of reference data (e.g., core data), inverting a petrophysical model using well logs and the reference data and, and varying input model parameter values within user-defined ranges such that the output of the petrophysical model matches the reference data. Advantageously, this yields a set of parameters where the petrophysical model output, porosity for example, is a statistically good to the petrophysical reference data. This result can be achieved by inversion or other known optimization technique.

By repeating the steps of the present invention multiple times, multiple sets of input model parameters can be generated thus resulting in a posteriori distribution for each of the input model parameters. At the end of this process, we have a set of posteriori uncertainty distributions for all the model parameters without the need to have an accurate a-priori uncertainty distribution.

### BRIEF DESCRIPTION OF THE DRAWINGS

A description of the present invention is made with reference to specific embodiments thereof as illustrated in the appended drawings. The drawings depict only typical embodiments of the invention and therefore are not to be considered limiting of its scope.

FIG. 1 shows a method for characterizing reservoir formation evaluation uncertainty in accordance with an embodiment of the present invention.

FIG. 2 shows a user interface for inputting variogram and core data parameters in accordance with an embodiment of the present invention.

FIG. 3 shows a user interface for inputting a-priori parameter ranges for optimizing petrophysical model parameters in accordance with an embodiment of the present invention.

FIGS. 4a and 4b are exemplary outputs from step 22 of FIG. 1; FIG. 4a is F-Test histograms in accordance with the present invention and FIG. 4b shows exemplary spatially bootstrapped optimized petrophysical model input parameters for M×N=100 iterations of steps 16 and 20 of FIG. 1.

FIG. 5 shows exemplary histograms for optimized petrophysical model input parameters in accordance with the present invention.

FIG. 6 shows exemplary well logs for selected reservoir properties as determined by a petrophysical model using the optimized petrophysical model input parameters in accordance with the present invention.

FIG. 7 shows an exemplary well log and related core sample data for a selected reservoir property.

### DETAILED DESCRIPTION OF THE INVENTION

Embodiments of the present invention for characterizing reservoir formation evaluation uncertainty are now described with reference to the appended drawings. The invention can be practiced as any one of or combination of hardware and software, including but not limited to a system (including a computer processor), a method (including a computer implemented method), an apparatus, an arrangement, a computer readable medium, a computer program product, a graphical user interface, a web portal, or a data structure tangibly fixed in a computer readable memory. An article of manufacture for use with a computer processor, such as a CD, pre-recorded disk or computer program storage medium having program code residing therein, also falls within the spirit and scope of the present invention.

Applications of the present invention include but are not limited to the characterization of porosity and saturation in a subterranean hydrocarbon reservoir. The appended drawings illustrate only typical embodiments of the present invention and therefore are not to be considered limiting of its scope and breadth.

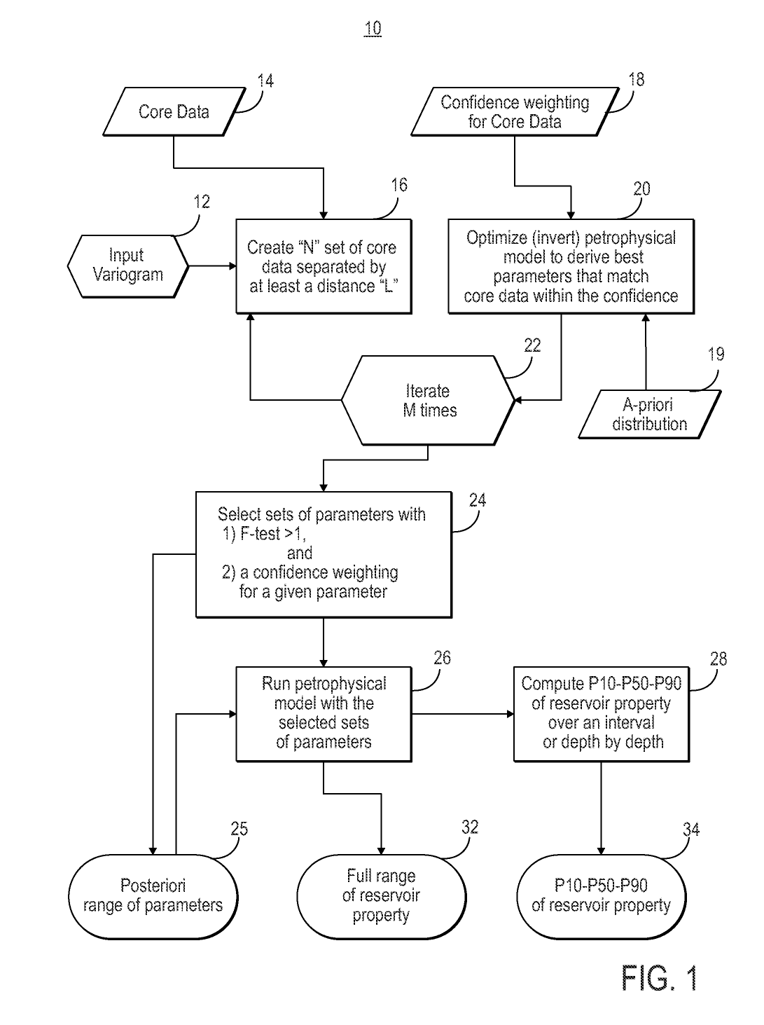

FIG. 1 shows an exemplary method 10 for characterizing reservoir formation evaluation uncertainty in accordance with the present invention. Generally, the method of the present invention includes the steps of: accessing petrophysical reference data; deriving an a-priori uncertainty distribution of petrophysical model input parameters and a non-uniqueness of calibration of field data, such as but not limited to well log, wireline log and logging while drilling (LWD) data, to the petrophysical reference data, such as but not limited to core, more accurate set of logs, complete log suite, etc.; deriving multiple petrophysical model solutions using the a-priori uncertainty distribution of petrophysical model input parameters that fit within a given tolerance a plurality of the petrophysical reference data; deriving a posteriori distribution of input model parameters from the multiple petrophysical model solutions; and applying the posteriori distribution of petrophysical model input parameters to derive an a-priori uncertainty distribution of selected petrophysical model outputs.

In one embodiment, the method first includes providing a correlation length L and selected petrophysical reference data (e.g., core data, sample data, etc.), steps 12 and 14 respectively, to create N subsets of randomly selected petrophysical reference data that are spatially independent, i.e., separated by at least a correlation length L, step 16. Step 14 includes providing petrophysical reference or sample data, which for example, may include cased hole samples or already assigned samples in a grid. These samples represent only a partial sampling of an available population as there is may be a limited number of boreholes or a limited number of cores (e.g., extracted from the boreholes). As a result, the data collected from the samples may be correlated, which includes data that is characterized with a certain degree of correlation. As a result, uncertainty exists because the available partial sample is only a small portion of a larger volume of rock to be characterized (e.g., in an entire region) and the data within the collected sample is correlated, i.e., dependent. Even if the number of samples may be relatively large, because samples are collected from locations that are near each other, the large number of samples may be dependent and also may not be representative of the larger volume to be characterized.

In another embodiment, step 12 of the present method includes inputting a variogram to select a set of independent data from a sample population containing dependent or correlated data. A variogram in a two-dimensional space is generally noted 2γ(δx,δy), where γ(δx,δy) is called the semi-variogram. The variogram is a function describing the degree of spatial dependence as a function of separation (δx,δy) between two points of a spatial random field or stochastic process Z(x,y). The variogram is used at step 16 to create N subsets of property data that are substantially spatially less correlated than the initial set of correlated sample data so as to apply a bootstrap process. N subsets (where N is greater than 2) are needed so as to achieve a statistically meaningful result.

A variogram can be generated from many sources. For example, a variogram can be generated by analyzing the original sample data (e.g., the sample core data) and analyzing the correlation of the sample data as a function of distance (δx,δy). The variogram can also be generated from conceptual models. In the present case, however, the variogram is generated by analyzing the original sample data correlation with distance. However, as it can be appreciated other methods for generating a variogram can also be used. For example, when the sample data are relatively close they are considered to be dependent but as distance increases the dependency or correlation in the sample data decreases. In other words, the distance is scaled by a variogram. Variogram distance, or correlation length, in one direction may not be equivalent to variogram distance in another direction. In this respect, variograms are ellipsoids in that the variation of the variogram along the east-west direction is different from the variation of the variogram along the north-south direction.

Variograms have a gamma value also called covariance. The gamma value varies from zero to one, when using normal scores. When using a normal score transform such as, for example, the standard deviation, the gamma value is equal to one when normalized by the standard deviation. Hence, it is generally assumed that if gamma values are greater than one then the sample data is considered to be independent. On the other hand, if gamma values are less than one then the sample data is dependent or correlated. The closer the gamma value to zero, the more the sample data is dependent or correlated.

The gamma value threshold can be selected by a user according to the sample data. If the sample data is highly correlated, for example, then selecting a gamma value threshold greater than one would eliminate a great number of data points which would render a bootstrap process on the sample data not useful. On the other hand selecting a gamma value threshold close to zero would leave most the correlated sample data which would also render a bootstrap operation on correlated sample data less useful. Therefore, the gamma value threshold is selected to achieve a compromise so as not to filter out most of the sample data but at the same time select sample data that is not highly correlated so as to obtain a meaningful bootstrap result. Therefore, the gamma value can be selected from the range between zero and approximately one. However, in order to achieve a good compromise, a gamma value between about 0.3 to about 1 can be selected. In the present example, a gamma value of approximately 0.5 is selected as the threshold. Hence, sample data that have a gamma value of less than approximately 0.5 is filtered out while sample data having a gamma value greater than approximately 0.5 (e.g., between approximately 0.5 and 1.0) is used.

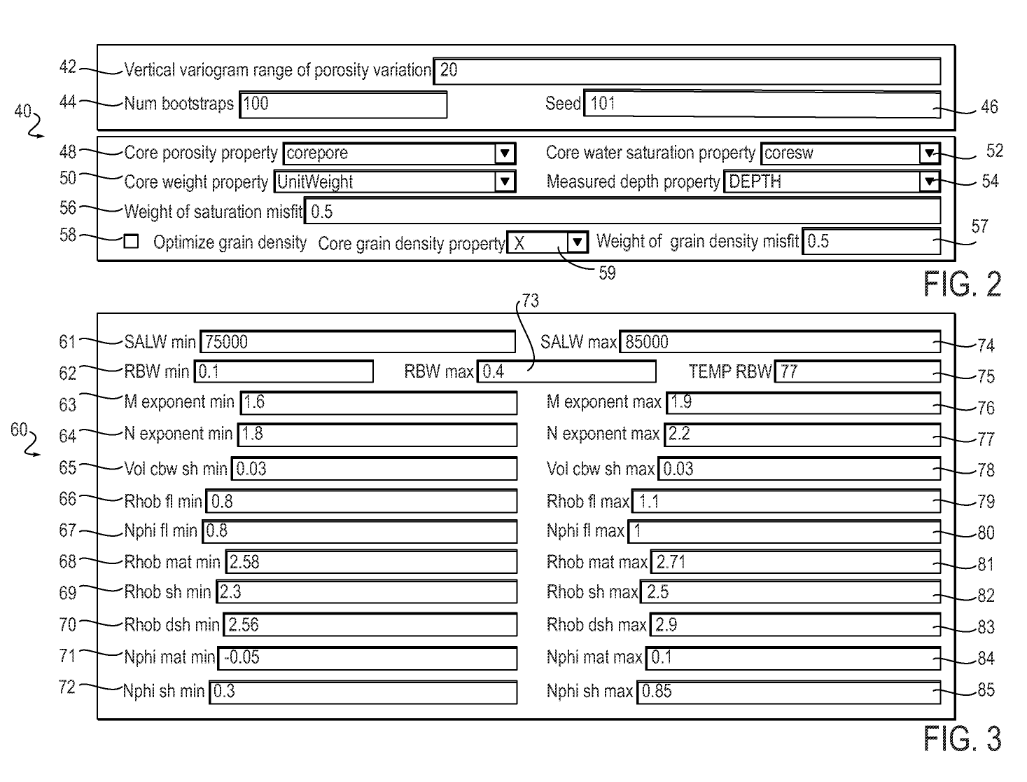

Referring again to FIG. 1, step 16 can be performed by bootstrapping as known by those skilled in the art to yield N “spatially bootstrapped” core data sets. Input correlation length data and/or core reference data can be accessed from a database or other electronic storage media, or provided via user interface 40 as shown in FIG. 2. The parameters and data provided via interface 40 relate generally to uncertainty core calibration. Interface 40 may include input fields for specifying the following parameters: correlation length (also referred to as the vertical variogram range of porosity variation) 42, number of bootstraps 44, seed 46, core porosity property 48, core weight property 50, core water saturation property 52, measured depth property 54, weight of saturation misfit core water saturation property 56, optimize grain density 59 and weight of grain density misfit parameter 57.

In one embodiment, after defining the N subset of substantially spatially less correlated or independent property data using the variogram, step 12, the method of the present invention randomly selects one set of spatially independent property data, step 16. A bootstrap process can be applied to each of the N subsets of spatially independent data, at step 16.

A bootstrap is a name generically applied to statistical resampling schemes that allow uncertainty in the data to be assessed from the data themselves. Bootstrap is generally useful for estimating the distribution of a statistical parameter (e.g., mean, variance) without using normal theory (e.g. z-statistic, t-statistic). Bootstrap can be used when there is no analytical form or normal theory to help estimate the distribution of the statistics of interest because the bootstrap method can apply to most random quantities, for example, the ratio of variance and mean. There are various methods of performing a bootstrap such as by using case resampling including resampling with the Monte Carlo algorithm, parametric bootstrap, resampling residuals, Gaussian process regression bootstrap, etc.

In a resampling approach, for example, given n independent observations where i=1, . . . , n and a calculated statistical parameter S, for example the mean, the uncertainty in the calculated statistical parameter S (e.g., mean) can be determined using a resampling bootstrap approach. In this case, n_{b} values of z_{bj}, j=1, . . . , n_{b} (where n_{b} is the number of bootstrap values which is equal to the given number n of independent observations) are drawn from the original data with replacement to obtain a bootstrap resample.

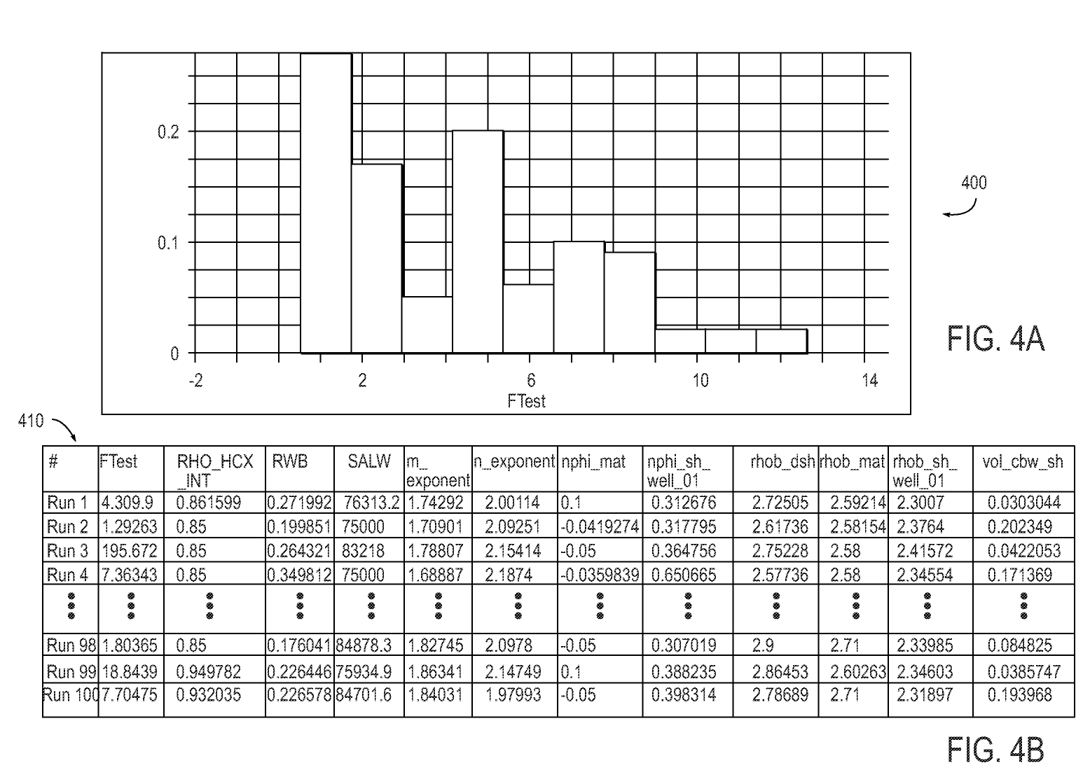

Referring again to FIG. 1, the N subsets of core data generated in step 16 are then used to optimize model parameters used in a reservoir petrophysical model, step 20, in order to match the output of reservoir properties computed by the petrophysical with the very same reservoir properties measured on the selected core data. Any optimization/inversion routine known in the art, such as particle swarm or genetic algorithms, can be used to perform step 20. In one embodiment, the optimization routine uses a-priori upper and lower bounds for each model parameter, step 19. Such ranges for the model parameters can be selected by a user interface as shown in FIG. 3, and may include model parameters 61-85, for example water salinity, or a subset thereof. The a-priori ranges for the model parameters in FIG. 3 are provided solely for purposes of computational efficiency, e.g., CPU time, and to be consistent with basic laws of physics, e.g., grain density cannot be negative. Note that the a-prior ranges do not represent a final distribution of model parameters like in a Monte-Carlo method.

In another embodiment, mineralogical analysis can be used to compute limits for specified model parameters. In accordance with another embodiment, a confidence level or weighting can be assigned in each core measurement, step 18, and applied as a “core weight” to the inverted values. The core weights can be applied to yield more realistic model parameters and a better fit between the reservoir property outputs of the petrophysical model and the reservoir properties measured on the selected core data. Steps 16 and 20 are then iterated M times, step 22, to yield M×N sets of optimized petrophysical model input parameters.

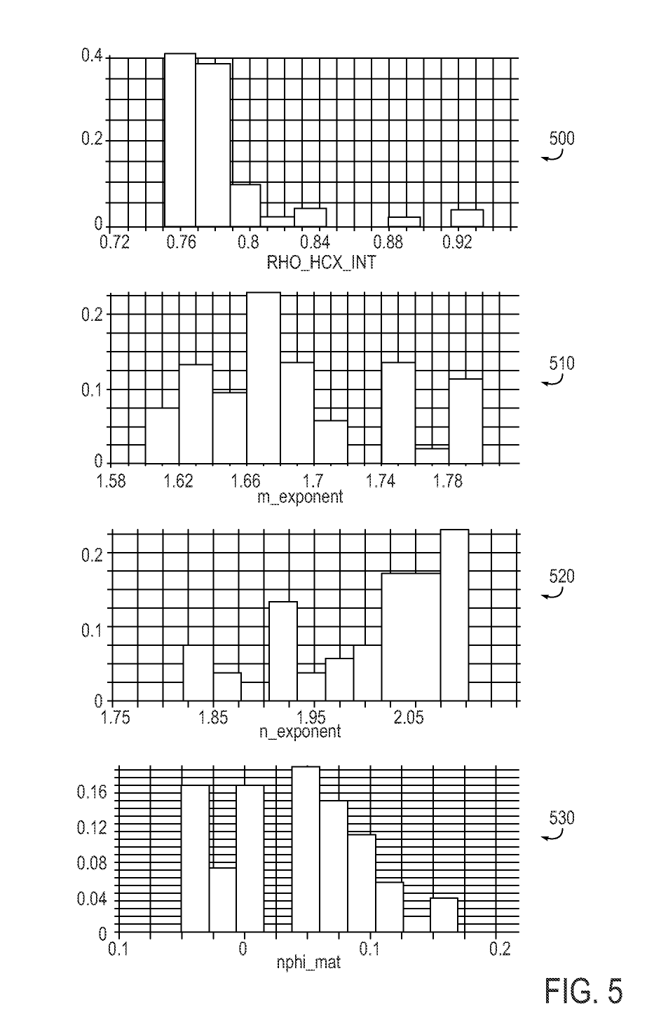

Next, for the M×N set of parameters, i.e., for each run M×N, the method of the present invention includes step 24 of providing a statistical indication, e.g., performing a test for statistic significance, of how good the fit is between the reservoir property outputs of the petrophysical model and the corresponding reservoir properties from the selected core data. An objective is to reject solutions that are poor fits to the petrophysical reference data. In one embodiment, step 24 can be performed by calculating an F-Test. The M×N set of petrophysical model input parameters can be ranked by F-test value (from high quality of confidence to low quality of confidence), step 24. An exemplary listing is shown in FIG. 4b. As described above, step 18 can be used to provide confidence weighting information to automatically select (or de-select) or weight any of the M×N sets of parameters. A parameter may be deselected or selected it is outside a given confidence interval.

Referring again to FIG. 1, the petrophysical model is then run with each of the M×N sets of optimal parameters, i.e., posteriori range of petrophysical model input parameters 25, having (a) an F-Test >1 and (b) are with a confidence weighting for a given parameter, step 26, to generate selected reservoir output property curves. Next, step 28 is run to compute P10, P50, and P90 reservoir properties from the N selected petrophysical model outputs at each depth by sorting the petrophysical model outputs for each property type and choosing the 10^{th}, 50^{th} and 90^{th} percentile values from this sorted list. Alternatively, P10, P50, and P90 reservoir properties can computed from the selected petrophysical model output, over a given interval, by sorting the mean value over an interval of the petrophysical model output for a designated property type to determine which sets of parameters in which of the selected runs created the 10^{th}, 50^{th}, and 90^{th} percentile values from this sorted list. The petrophysical model output from these P10, P50, and P90 runs, chosen interval by interval, combined over all intervals is the final P10, P50, and P90 petrophysical model.

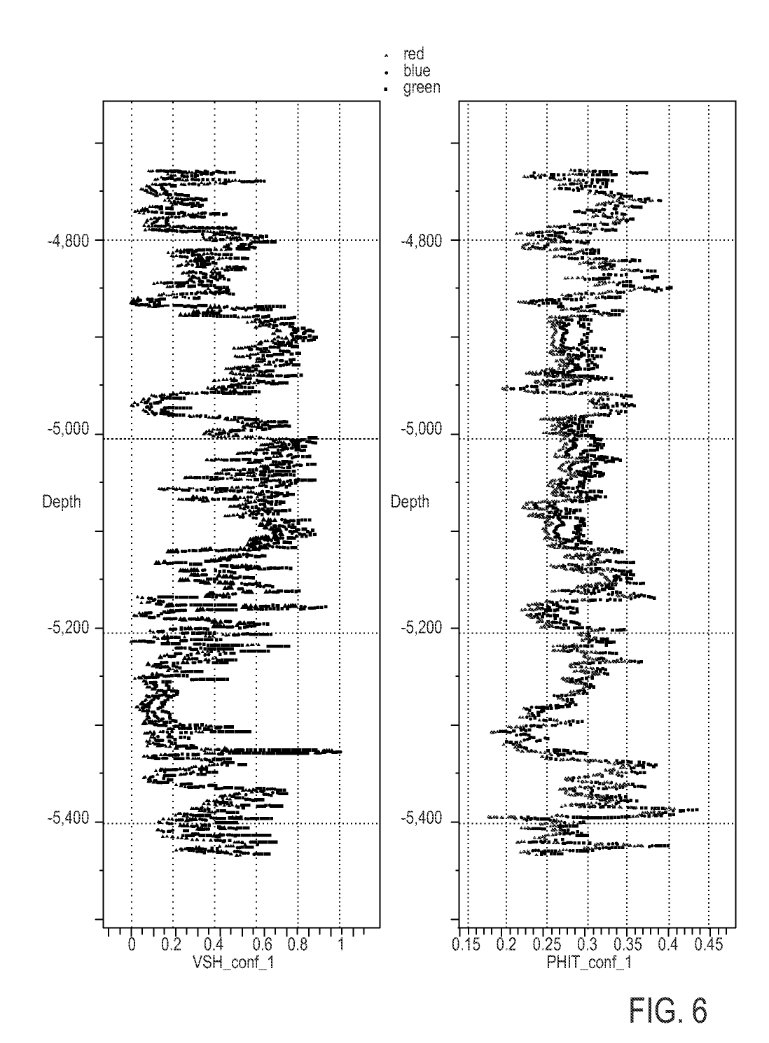

FIGS. 5-7 show final results of the present invention. FIG. 5 is set of histograms 500, 510, 520 and 530 of reservoir model parameters RHO_HCX_INT, m_exponent, n_exponent and nphi_mat of the petrophysical model (such as grain density, water salinity, etc) that match the petrophysical reference (core data) within the specified confidence weighting.

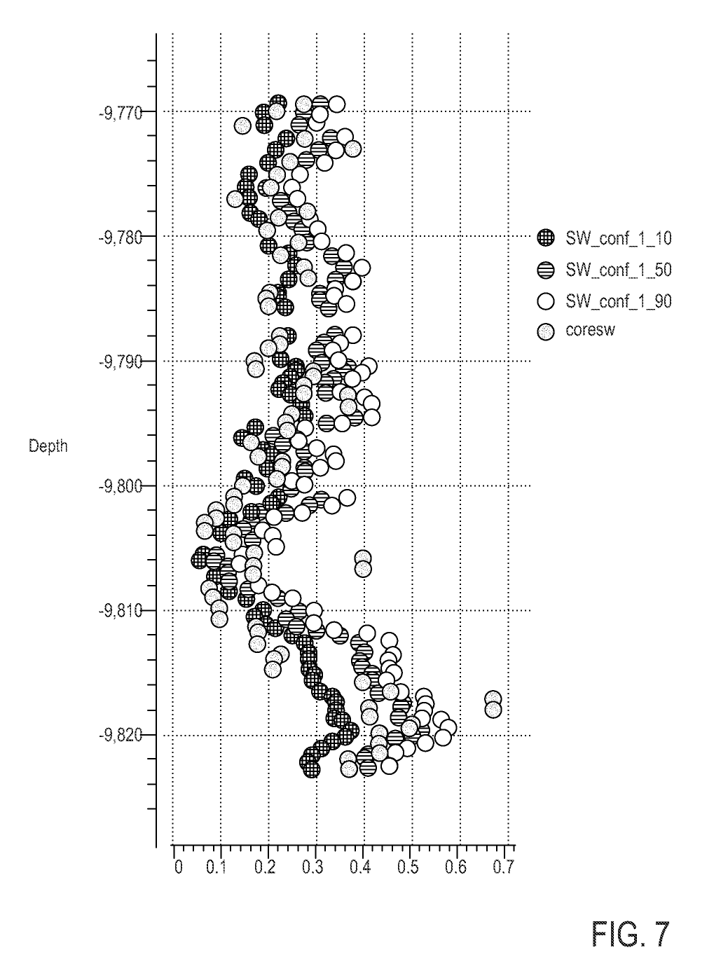

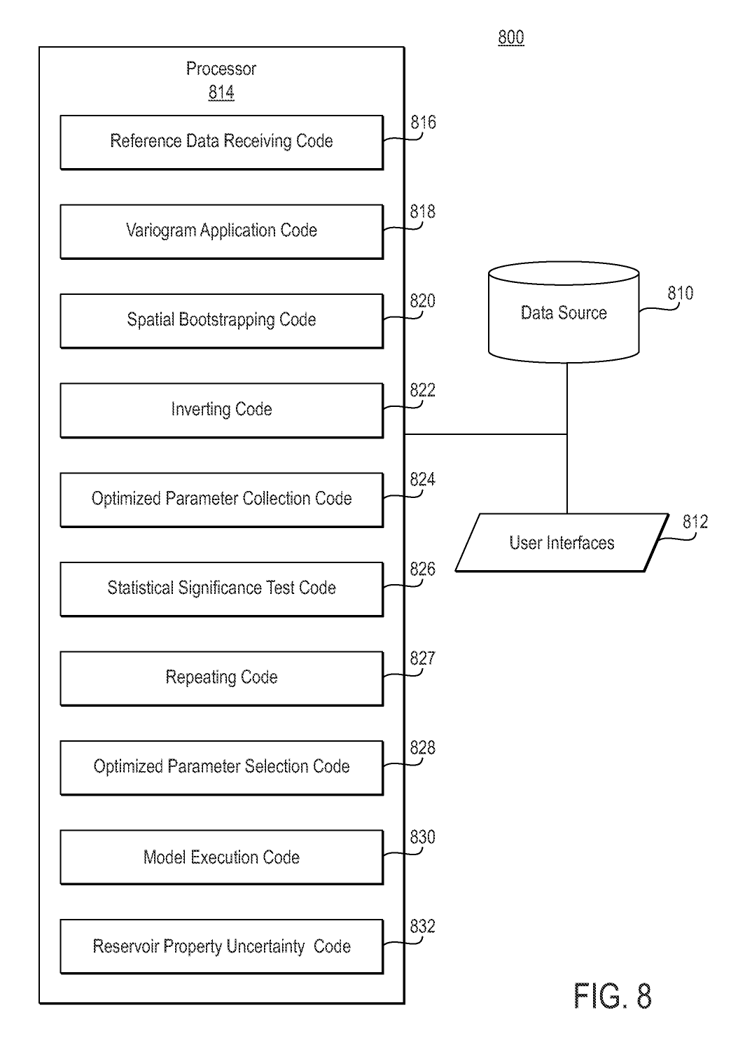

FIG. 6 is set of three well logs for each of reservoir properties PHI_conf_{—}1 and VSH_conf_{—}1 (such as porosity, saturation, etc) coming from the petrophysical model and that represent the P10-P50-P90 among the M×N runs of the petrophysical model ran with the measured well log and the M×N set of parameters. These P10-P50-P90 reservoir properties are therefore within the bounds of the confidence weighting we gave to the core data (ref)]. FIG. 7 is a well log showing that related core samples (denoted by x's) are substantially within the P1P50-P90 distributions.

FIG. 8 shows a system 800 for characterizing hydrocarbon reservoir formation evaluation uncertainty. The system includes a data source 810, a user interface 820 and a computer processor 814. The computer processor 814 is operatively in communication with the data source 810 and configured to access the petrophysical reference data and to execute a computer executable code responsive to the petrophysical reference data. In one embodiment, the computer executable code includes ten code or module elements: a first code 816 for accessing the petrophysical reference data; a second code 818 for applying a variogram to the sample petrophysical data to select a plurality of subsets N of data, the N subsets of data being substantially less correlated than the sample petrophysical data; a third code 820 for applying a spatial bootstrap process on each of the N subsets of data to obtain a plurality of bootstrap data sets from each of the N subsets of data; a fourth code 822 for inverting, each of the N subsets of data, a petrophysical model to generate a set of optimized petrophysical model input parameter values, wherein the inverting code varies model input parameter values for the petrophysical model within user-defined ranges such that output of the petrophysical model matches the petrophysical reference data within a predetermine threshold; a fifth code 824 for collecting the set of optimized petrophysical model input parameters values; a sixth code 826 for performing a statistical significance test on each set of optimized petrophysical model input parameter values; a seventh code 827 for causing the spatial bootstrap process and inverting to be repeated M times to generate M×N sets of optimized petrophysical model input parameter values; an eight code 828 for selecting from M×N sets of optimized petrophysical model input parameter values those sets optimized petrophysical model input parameter values that satisfy at predetermined criteria for the statistical significance test; a ninth code 830 for executing the petrophysical model using the selected sets of optimized petrophysical model input parameter values; and a tenth code 832 for determining selected percentiles representative of selected reservoir uncertainties.

User interfaces 812 may include one or more displays or screens for inputting variogram, reference data, and a-priori model input parameter ranges as shown in FIGS. 2 and 3. Interfaces 812 may also include screens for selectively displaying selected percentiles representative of selected reservoir uncertainties.

In addition to the embodiments of the present invention described above, further embodiments of the invention may be devised without departing from the basic scope thereof. For example, it is to be understood that the present invention contemplates that one or more elements of any embodiment can be combined with one or more elements of another embodiment. It is therefore intended that the embodiments described above be considered illustrative and not limiting, and that the appended claims be interpreted to include all embodiments, applications and modifications as fall within the true spirit and scope of the invention.

What is claimed is:

1. A computer-implemented method for characterizing hydrocarbon reservoir formation evaluation uncertainty, comprising:
inputting, into a computer, petrophysical reference data comprising substantially spatially correlated data;
choosing a plurality of subsets N of data, the N subsets of data each being substantially less spatially correlated than the petrophysical reference data but still representative of the petrophysical reference data;
applying, using the computer, a bootstrap process on each of the N subsets of data to obtain a bootstrap data set from each of the N subsets of data;
for each of the bootstrap datasets, inverting, using the computer, a petrophysical model to generate a set of optimized petrophysical model input parameter values, wherein the inverting step comprises varying model input parameter values for the petrophysical model within user-defined ranges such that output of the petrophysical model matches is a best fit to petrophysical reference data;
collecting, using the computer, the set of optimized petrophysical model input parameters;
performing, using the computer, a statistical significance test the set of optimized petrophysical model input parameters and the corresponding fit to the petrophysical reference data;
repeating, using the computer, the bootstrap process and inverting step M times to generate M×N sets of optimized petrophysical model input parameters;
selecting, using the computer, from M×N sets of optimized petrophysical model input parameters those sets optimized petrophysical model input parameters that satisfy at predetermined criteria for statistical significance;
executing, using the computer, the petrophysical model using the selected sets of optimized petrophysical model input parameters on a plurality of data within a hydrocarbon reservoir formation;
determining, using the computer, selected percentiles representative of selected reservoir uncertainties from the distribution of values produced by different sets of optimized petrophysical model input parameters.

2. The computer-implemented method of claim 1, wherein the selection step comprises selecting optimized petrophysical model input parameters comprising using an F-Test.

3. The computer-implemented method of claim 1, wherein the step of determining selected percentiles representative of selected reservoir uncertainties comprises selecting P10, P50 and P10 percentiles.

4. The computer-implemented method of claim 1, wherein the step of determining spatial correlation is done by variogram analysis

5. A system for characterizing hydrocarbon reservoir formation evaluation uncertainty:
a data source comprising petrophysical reference data;
a computer processor operatively in communication with the data source, the processor configured to access the petrophysical reference data and to execute a computer executable code responsive to the petrophysical reference data, the computer executable code comprising:
a first code for accessing the petrophysical reference data;
a second code for applying a variogram to the sample petrophysical data to select a plurality of subsets N of data, the N subsets of data being substantially less correlated than the sample petrophysical data;
a third code for applying a spatial bootstrap process on each of the N subsets of data to obtain a plurality of bootstrap data sets from each of the N subsets of data;
a fourth code for inverting, each of the N subsets of data, a petrophysical model to generate a set of optimized petrophysical model input parameter values, wherein the inverting code varies model input parameter values for the petrophysical model within user-defined ranges such that output of the petrophysical model matches the petrophysical reference data within a predetermine threshold;
a fifth code for collecting the set of optimized petrophysical model input parameters values;
a sixth code for performing a statistical significance test on each set of optimized petrophysical model input parameter values;
a seventh code for causing the spatial bootstrap process and inverting to be repeated M times to generate M×N sets of optimized petrophysical model input parameter values;
an eight code for selecting from M×N sets of optimized petrophysical model input parameter values those sets optimized petrophysical model input parameter values that satisfy at predetermined criteria for the statistical significance test;
a ninth code for executing the petrophysical model using the selected sets of optimized petrophysical model input parameter values; and
a tenth code for determining selected percentiles representative of selected reservoir uncertainties.

6. A computer-implemented method for characterizing hydrocarbon reservoir formation evaluation uncertainty, comprising:
accessing, via a computer, petrophysical reference data;
deriving, via the computer, an a-priori uncertainty distribution of petrophysical model input parameters and a non-uniqueness of calibration of field data to the petrophysical reference data;
deriving, via the computer, multiple petrophysical model solutions using the a-priori uncertainty distribution of petrophysical model input parameters that fit within a predetermined tolerance a plurality of the petrophysical reference data;
deriving, via the computer, a posteriori distribution of input model parameters from the multiple petrophysical model solutions; and
applying, via the computer, the posteriori distribution of petrophysical model input parameters to derive an a-priori uncertainty distribution of selected petrophysical model output.
